(19) United States
(12) Patent Application Publication
(10) Pub. No.: US 2006/0164047 A1
(43) Pub. Date: Jul. 27, 2006

(54) Switching regulator, especially down converter, and switching/regulating method

(76) Inventor: Hartmut Ressel, Pfullingen (DE)

Correspondence Address: KENYON & KENYON LLP, ONE BROADWAY, NEW YORK, NY, 10004, US

(21) Appl. No.: 10/517,742

(22) PCT Filed: Apr. 1, 2003
(86) PCT No.: PCT/DE03/01057

§ 371 Date: Jul. 20, 2005

(30) Foreign Application Priority Data
Jun. 12, 2002 (DE) 102 26 031.1

(51) Int. Cl. G05F 1/656; G05F 1/10

(52) U.S. Cl. 323/222

(57) ABSTRACT

A switching regulator, a step-down transformer in particular, is described, which has a switching device for generating a pulsed signal from an input signal as a function of a switching signal; a filtering device for filtering the pulsed signal and for outputting a smoothed output signal; a controllable amplifier device for generating the switching signal from a reference signal and an actual value signal obtained from the output signal via a feedback device as a function of a compensation signal; and a compensation-signal generating device (2) for generating the compensation signal (3) from the input signal (1). A switching regulation method is also described.

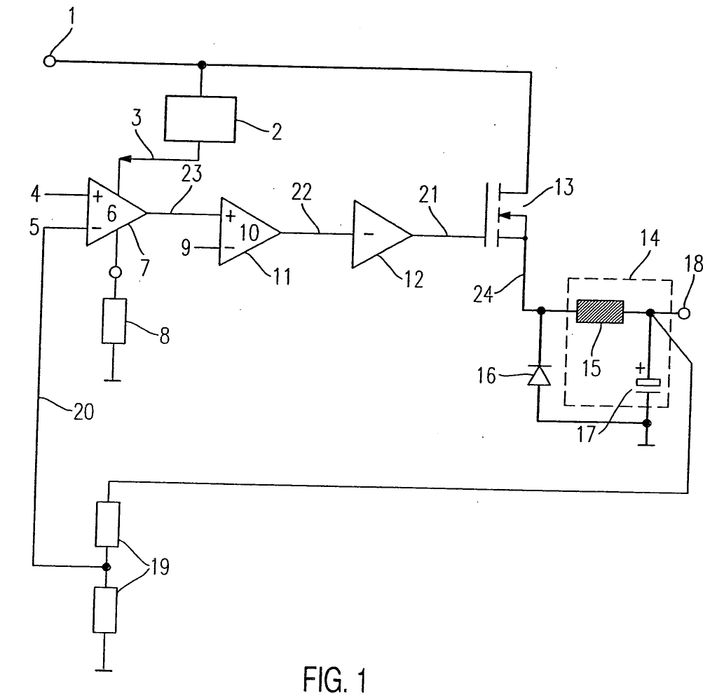

### FIELD OF THE INVENTION

The present invention relates to a switching regulator, a step-down transformer in particular, and a switching regulation method.

### BACKGROUND INFORMATION

Switching regulators (SR), such as buck converters or step-down converters, are used in many applications, for voltage matching and voltage reduction in particular, in switched-mode power supplies, for example.

In direct voltage supply circuits (power supply units) voltage is generally regulated by switching regulators via a timing voltage which is applied to the control terminal of a power transistor. In the simplest case, a timing frequency is derived by the regulator from the direct voltage (controlled variable) to be regulated according to the deviation from the reference variable (system deviation) and this timing frequency times the power transistor and thus provides the regulated output direct voltage, after low-pass filtering in particular.

The open loop gain of a switching regulator results essentially from a gain v_{R} of a control amplifier, gain V_{PWM} of a pulse-width modulator (PWM), ratio kist of an actual voltage divider of the output voltage in the feedback path, and the gain or damping H_{TPLC} of an LC low-pass filter at the output of a power amplifier of the switching regulator: (V=kactual×v_{R}×V_{PWM}×H_{TPLC}).

Gain factor V_{PWM} of the pulse-width modulator results from the quotient between a battery voltage U_{BAT} (input signal) and a delta voltage U_{osc} which is supplied to the pulse-width modulator (V_{PWM}=U_{BAT}/U_{osc}), delta voltage U_{osc} being 1.25 V_{SS}, for example.

Due to the great fluctuation range of battery voltage U_{BAT}, of approximately 6 V to 40 V, and possibly even 60 V, which must be taken into account, gain factor V_{PWM} of pulse-width modulator (PWM) has a relatively large dynamic range. As a result, the total gain varies by a factor of 10 (20 dB) due to the battery voltage variation range alone, which may result in stability problems of the overall control circuit, or in control and accuracy losses in the case of a reserve established on the basis of the maximum gain.

Changes in the battery voltage, in particular sudden changes, are identified and subsequently adjusted in the feedback path of the control circuit of a switching regulator only with a relatively long delay time, which results in dynamic harmonics in the output voltage. Relevant for the delay is the LC low-pass filter (H_{TPLC}) having a cut-off frequency f_{gTP} of:
f_{gTP}=(½π)×(1/(LC)^{0.5}).

A typical method for circumventing the above-named problems is presented in M.R. BORGHI Smart Power ICs, Springer Verlag 1996. The amplitude of delta voltage U_{osc} supplied to the pulse-width modulator is regulated as a function of the battery voltage U_{osc}=f(U_{BAT}), delta voltage U_{osc} being in the range between 200 mV and 2 V, for example. One disadvantage in the case of relatively small amplitudes of delta voltage U_{osc} in a timed system results due to the resolution inaccuracy, which is critical. In addition, amplitude feedforward compensation is relatively complicated to implement.

Another typical method for circumventing the above-described problems is a pre-distortion of delta voltage U_{osc}, the oscillator voltage supplied to the pulse-width modulator being only quasi-delta shaped, and a linear section in the area of the tip of the delta having an exponential area where no feedforward effect is achieved, since the oscillator does not change its voltage amplitude, in particular not as a function of battery voltage U_{BAT}, and thus no direct compensation regulation occurs (see also MULLER RS, KAMINS TI (1986) Devices For Electronics Integrated Circuit, John Wiley & Sons).

### SUMMARY OF THE INVENTION

An object of the present invention is to provide a switching regulator, in particular having feedforward compensation, and also a switching regulation method having a gain which is essentially independent of an input signal.

The present invention is based on the fact that gain VR of a control amplifier is approximately proportional to the battery voltage.

The object of the present invention as recited in the preamble is achieved in particular by the fact that a compensation device controls gain factor VR as a function of an input voltage, in particular a fluctuating input voltage (U_{BAT}, for example), in such a way that the overall gain of the switching regulator remains essentially constant over battery voltage U_{BAT}.

According to an advantageous refinement, an amplifier device has a complex grounded resistor, in particular for adjusting a primary gain and/or frequency compensation.

According to another preferred refinement, a filtering device has a low-pass filter, in particular having an inductance and a capacitance and a diode connected in parallel thereto.

According to another preferred embodiment, the oscillator signal supplied to the pulse-width modulating device has a delta oscillator voltage.

According to another preferred refinement, a switching device has a transistor, a MOSFET in particular.

### BRIEF DESCRIPTION OF THE DRAWING

The FIGURE shows the block diagram of a switching regulator, having feedforward compensation in particular, to elucidate an embodiment according to the present invention.

### DETAILED DESCRIPTION

The FIGURE shows the block diagram of a switching regulator, having feedforward compensation in particular, to elucidate an embodiment according to the present invention. The FIGURE, an input signal 1, a battery voltage U_{BAT} in particular, is supplied to a compensation device 2, a feedforward compensation module (FFK) in particular, which generates a compensation signal 3, a compensation current I_{FFK} in particular, as a function of the amplitude of input signal 1.

An amplifier device 7, a control amplifier R_{V} or transconductance amplifier in particular, receives compensation signal 3 and modifies gain factor 6 V_{R} of amplifier device 7 according to compensation signal 3. A complex resistor 8 is connected to amplifier device 7 and is essentially used for adjusting the primary gain of amplifier device 7 and/or the frequency compensation. A reference signal 4, a reference voltage U_{REF} in particular, and an actual value signal 5, an actual voltage U_{actual} in particular, are also supplied to amplifier device 7 to generate an amplifier signal 23.

An oscillator signal 9, a delta oscillator voltage U_{osc} in particular, having any desired, essentially constant, amplitude is also supplied, as is amplifier signal 23, to a pulse-width modulating device 11, a pulse-width modulator (PWM) in particular, which generates a pulse-width modulated signal 22 amplified by a gain v_{PWM}, which is supplied to an additional amplifier device 12 having gain vₚ. A switching signal 21 is generated in amplifier device 12, which is essentially used as a power adapter for actuating a switching device 13.

Switching device 13, a MOSFET power amplifier in particular, switches through input signal 1 as a function of switching signal 21 to a filtering device 14 and as a result generates a pulsed signal 24, which is smoothed in filtering device 14, which has a low-pass filter in particular having a serial inductance 15 and a grounded capacitance 17 connected downstream from inductance 15.

A freewheeling diode 16, which is used for protecting filtering device 14 against voltage surges, among other things, is connected to ground in parallel to filtering device 14. Pulsed signal 24 is smoothed in filtering device 14 to yield output signal 18, a voltage in particular, which is supplied to amplifier device 7 (actual value signal 5) via a resistor network 19, a voltage divider 19 in particular having gain or division kist, and a feedback path 20. Gain v_{R} or transconductance s_{R} of control amplifier 7 is corrected using battery voltage U_{BAT} (input signal 1) in such a way that the product v₁=(U_{BAT}/U_{osc})×v_{R} remains constant over the battery voltage.

Delta oscillator voltage U_{osc} may be selected arbitrarily, e.g., U_{osc}=1.25 V. The loop gain in the control circuit of a buck converter, which in first approximation is independent of the battery voltage according to the present invention, represents an implementation of a feedforward compensation, i.e., the control amplifier or pulse-width modulator responds to a sudden change in the battery voltage immediately, without delay of the output-side low-pass filter.

The implementation of such a switching regulator using feedforward compensation is inexpensive and requires little space.

For gain v_{R} of control amplifier RV, the following applies:
v_{R}=Z×[1/(R×k×U_{BAT})],
where Z represents the complex resistance of a selectable external resistor, having an ohmic and/or capacitive resistance in particular. The product of transconductance S_{R} and complex resistance Z is also equal to gain v_{R} of control amplifier RV, transconductance S_{R} being compensation current I_{FFK} divided by temperature voltage U_{T}, and compensation current I_{FFK} being generatable from a ring-type current source and satisfying the equation I_{FFK}=U_{c}/(R×k×U_{BAT}), R being the Tk0 resistance of the ring-type current source, and k being a factor for adjusting gain v_{R}. By combining the above equations and equation V_{PWM}=U_{BAT}/U_{osc}, the product of the two gains V_{R} and V_{PWM}=v1 becomes v1=Z/(R×k×U_{osc}), which in first approximation is independent of the battery voltage and in the event of battery voltage surges corrects the gain dynamically, without delay time of the output low-pass filter, so that harmonics in output voltage Vₒᵤₜ are prevented.

Although the present invention was described above with reference to a preferred exemplary embodiment, it is not limited thereto, but may be modified in many ways.

Although in the example above the compensation device emits a current signal for controlling the gain factor of the amplifier device, another signal form (voltage signal, optical signal, etc.) is also conceivable here or for the other mentioned signals. A different oscillator output signal form is also conceivable, as well as a modified filtering device or the omission of the additional amplifier device having gain factor vₚ.

The present invention is also not limited to the above-mentioned applications.

1-16. (canceled)

17. A switching regulator, comprising:
a switching device for generating a pulsed signal from an input signal as a function of a switching signal;
a filtering device for filtering the pulsed signal and for outputting a smoothed output signal;
a feedback device;
a controllable amplifier device for generating the switching signal from a reference signal and an actual value signal obtained from the smoothed output signal via the feedback device as a function of a compensation signal; and
a compensation-signal generating device for generating the compensation signal from the input signal.

18. The switching regulator as recited in claim 17, wherein:
the switching regulator is a step-down transformer.

19. The switching regulator as recited in claim 17, wherein:
the amplifier device includes a complex grounded resistor, for adjusting at least one of a primary gain and a frequency compensation.

20. The switching regulator as recited in claim 17, wherein:
the filtering device includes a low-pass filter.

21. The switching regulator as recited in claim 20, wherein:
the low-pass filter includes an inductance and a capacitance.

22. The switching regulator as recited in claim 17, further comprising:
a diode is connected in parallel to the filtering device in order to protect the filtering device.

23. The switching regulator as recited in claim 17, further comprising:
a resistor network including a voltage divider having essentially ohmic resistors and connected to the amplifier device via the feedback device.

24. The switching regulator as recited in claim 17, wherein:
the controllable amplifier device includes a pulse-width modulating device for generating a pulse-width modulated signal, corresponding to the switching signal, from an oscillator signal and an amplifier signal.

25. The switching regulator as recited in claim 24, wherein:
the oscillator signal has a delta voltage-shaped curve.

26. The switching regulator as recited in claim 17, wherein:
the compensation signal is a current signal.

27. The switching regulator as recited in claim 17, wherein:
the switching device includes a MOSFET transistor.

28. The switching regulator as recited in claim 17, wherein:
the input signal includes a quasi-constant battery voltage.

29. The switching regulator as recited in claim 17, further comprising:
a circuit arranged between the pulse-width modulating device and the switching device, the circuit including an additional amplifier device.

30. A switching regulation method, comprising:
generating a compensation signal from an input signal in a compensation-signal generating device;
generating a switching signal from a reference signal and an actual value signal obtained from the output signal via a feedback device as a function of the compensation signal in a controllable amplifier device;
generating a pulsed signal from the input signal as a function of the switching signal in a switching device; and
filtering the pulsed signal in a filtering device and outputting a smoothed output signal.

31. The method as recited in claim 30, further comprising:
generating an amplifier signal via a complex resistor connected to the controllable amplifier device.

32. The method as recited in claim 30, further comprising:
supplying the smoothed output signal to the controllable amplifier device via a resistor network, including a voltage divider in particular provided with ohmic resistors, and the feedback device.

33. The method as recited in claim 30, further comprising:
generating a pulse-width modulated signal corresponding to the switching signal from an oscillator signal and the amplifier signal in the controllable amplifier device in a pulse-width modulating device.

34. The method as recited in claim 33, further comprising:
amplifying the pulse-width modulated signal in an additional amplifier device before the switching device is triggered.
